(19) United States
(12) Patent Application Publication
(10) Pub. No.: US 2008/0077552 A1
(43) Pub. Date: Mar. 27, 2008

(54) Systems and methods for analyzing multiple states in one or more groups of data

(76) Inventor: Ronald Sanborn, South Windsor, CT (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/527,909

(22) Filed: Sep. 27, 2006

(51) Int. Cl. G06F 17/30

(52) U.S. Cl. 707/2

(57) ABSTRACT

Systems and methods are disclosed that allow a user to create a template for analyzing data in a database. The template specifies at least one table, columns from at least one table to be included in the analysis, and analysis options for the columns. The options for one of the columns are independent from the options for other columns.

### BACKGROUND

Database administrators and programmers typically use the Structured Query Language (SQL) to define executable statements and queries that provide the ability to modify or retrieve data from a database server. SQL offers a flexible language for manipulating databases of all shapes and sizes.

Database analysis tools currently available on the market are limited to single dimensional data generally. Many are coded to support specific types of analysis. None operate based on generic data structures that define the analysis operation in a generic way. None perform analysis on the domain of a SQL query or function and are designed to support existing data or future data types by means of template analysis data structures.

### SUMMARY

Systems and methods are disclosed that allow a user to create a template for analyzing data in a database. The template specifies at least one table, columns from at least one table to be included in the analysis, and analysis options for the columns. The options for one of the columns are independent from the options for other columns.

### BRIEF DESCRIPTION OF THE DRAWINGS

The accompanying drawings, which are incorporated in and form a part of this specification, illustrate embodiments of the invention and, together with the description, serve to explain its principles:

FIG. 1 shows an embodiment of a computer system including components for analyzing one or more specified groups of data in a database;

FIG. 2 shows a diagram of an embodiment of a call tree of the components of FIG. 1 for database analysis;

FIG. 3 shows an embodiment of functions performed by the user interface component of FIG. 1;

FIG. 4 shows an embodiment of a form generated by a user interface component to create a database connection;

FIG. 5 shows an embodiment of a form generated by a user interface component to create, modify, or delete an analysis template;

FIG. 6 shows an embodiment of a form generated by a user interface component to define options for an analysis template;

FIG. 7 shows an embodiment of a form generated by a user interface component to define replacements and/or formats of data defined as template parameters;

FIG. 8 shows an embodiment of a form generated by a user interface component to define indexes for an analysis template;

FIG. 9 shows an embodiment of a form generated by a user interface component to add references to state entities that contain references to criteria rules, rulesets or rulesetgroups that describe SQL statements, to a project in a workspace;

FIG. 10 shows an embodiment of a form generated by a user interface component to add criteria and rules as well as rulesets and rulesetgroups to a project;

FIG. 11 shows an embodiment of a form generated by a user interface component to specify state entities that contain references to associated criteria, rules, rulesets or rulesetgroups and that are linked to templates as a selection for database analysis;

FIG. 12 shows an embodiment of a form generated by a user interface component to display results of the analysis;

FIG. 13 shows an embodiment of a form generated by a user interface component to display further detail on the results of the analysis;

FIG. 14 shows methods included in an embodiment of the compare component of FIG. 1; and

FIGS. 15A and 15B show methods included in embodiments of the analyzer and analyzers components of FIG. 1.

### DETAILED DESCRIPTION OF THE DRAWINGS

Systems and methods are disclosed that enable a user to create templates for multilayered analysis of information in a database. Data from virtually any field can be analyzed including, but not limited to, the analysis of genetic data, financial data, insurance policy data, drug research data, manufacturing data, communications data, and retail data. The result of the analysis may be used to diagnose problems, and develop solutions to problems based on the type of data that is analyzed. The analysis may be configured to find intersections, unions, conflicts, as well as other set operations that are available in multi-state data vectors. The analysis can further identify and report the elements that exist, do not exist, are the result of a set operation, or are within the domain of a query or group of queries or a function in a generic non-application-specific manner.

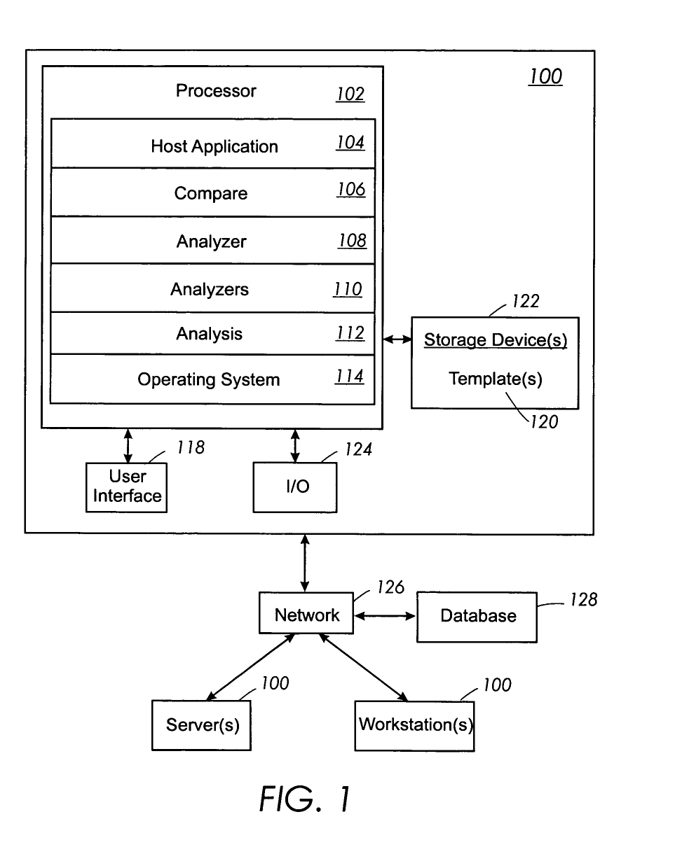

Referring to FIG. 1, an embodiment of system 100 is shown that includes processor 102 configured to execute logic instructions for host application 104, compare module 106, analyzer module 108, analyzers modules 110, analysis module 112, and operating system 114. Processor 102 can also communicate with user interface 118, which allows a user to enter data and commands, and view information.

Host application 104 can be configured to invoke compare module 106 via user interface 118, a script, another application program, or other suitable technique. Host application 104 and user interface 118 can be further configured to allow a user to create/modify/delete analysis templates 120, which can be stored in a suitable storage device 122, such as magnetic memory, a local, remote or network disk drive or other suitable storage. Analysis templates 120 provide information regarding database tables to be analyzed, options for performing the analysis, and options for viewing/storing the analysis results.

Embodiments disclosed herein may be implemented in a variety of computer system configurations such as servers and/or workstations. Any suitable computer systems can be used, such as personal computers, hand-held devices, multi-processor systems, microprocessor-based or programmable consumer electronics, network PCs, network adapters, minicomputers, mainframe computers and the like. Embodiments of the invention may also be practiced in distributed computing environments, where tasks are performed by remote processing devices, such as server(s) and/or workstations that are linked through a communications network 126 such as the Internet. In a distributed computing environment, program modules may be located in both local and remote memory storage devices. Additionally, some embodiments may be implemented as logic instructions and distributed on computer readable media or via electronic signals.

Processor 102 and user interface 118 can be configured to use one or more input/output (I/O) devices 124 that may include, but are not limited to, devices such as video monitors, track balls, mice, keyboards, microphones, touch-sensitive displays, transducer card readers, magnetic or paper tape readers, tablets, styluses, voice or handwriting recognition systems, and/or other suitable types of devices.

System 100 may optionally be coupled to a computer and/or telecommunications network 126, e.g., a local area network and/or a wide area network such as the Internet. With such a network connection, system 100 can receive information from the network 126, or output information to the network 126 during processing. Such information, which can be represented as a sequence of instructions to be executed using processor 102, may be received from and output to the network 126, for example, in the form of a computer data signal embodied in a carrier wave.

Computer system 100 can include any number of processors 102 configured to communicate with one or more storage devices 122 such as a random access memory (RAM), read only memory (ROM), a CD-ROM, and/or magnetic disk drive. Storage devices 122 can be used to store files such as analysis templates 120, executable program files, and data files including data in one or more databases 128. Databases 128 can be implemented using any suitable database structure such as SQL, Oracle, among others.

Operating system 114 can be the UNIX, LINUX, Windows, or other suitable operating system that is capable of supporting processor 102, interfacing with network 126, storage devices 122, user interface 118, and I/O devices 124, and executing logic modules, such as host application 104, compare component 106, and analyzer component 108.

Note that host application 104 may be hosted by a traditional graphical user interface software application or integrated with a Web Server or other application software. The data structure of template 120 may describe data to be analyzed from ASCII, XML, SQL Database Data or Schema, Binary Data as well as other suitable types of stored data.

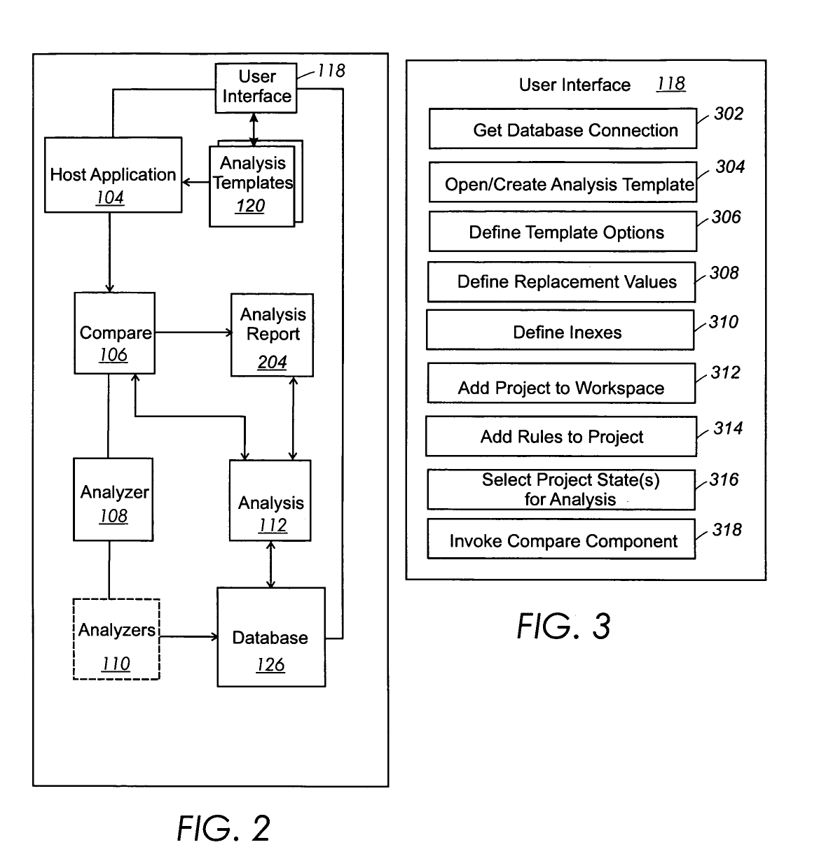

FIG. 2 shows a diagram of an embodiment of a call tree of relevant components of FIG. 1 for performing database analysis. In the embodiment shown, host application 104 can invoke user interface 118, access analysis templates 120, and invoke compare component 106. The compare component 106 can invoke analyzer component 108, analysis component 112, and generate analysis report(s) 204. Some of the parameters from analysis templates 120 can be provided by host application 104 to compare component 106 as arguments in a call list, as a pointer to a location in memory or a file where the parameters are stored, or other suitable method. In some embodiments, compare component 106 can access analysis templates 120 directly.

Analyzer component 108 can perform the analysis requested by compare component 106, and can optionally invoke analyzers component 110 when multiple tables in database 126 are analyzed.

FIG. 3 shows functions performed by an embodiment of user interface component 118 of FIG. 1. In the embodiment shown, the functions include get database connection function 302, open/create analysis template function 304, define template options function 306, define replacement values function 308, define indexes function 310, add project to workspace function 312, add rules to project function 314 where a rule is a reference to a criteria, rule, ruleset or rulesetgroup entity referenced by a state entity, select project(s) for analysis function 316, and invoke compare component function 318.

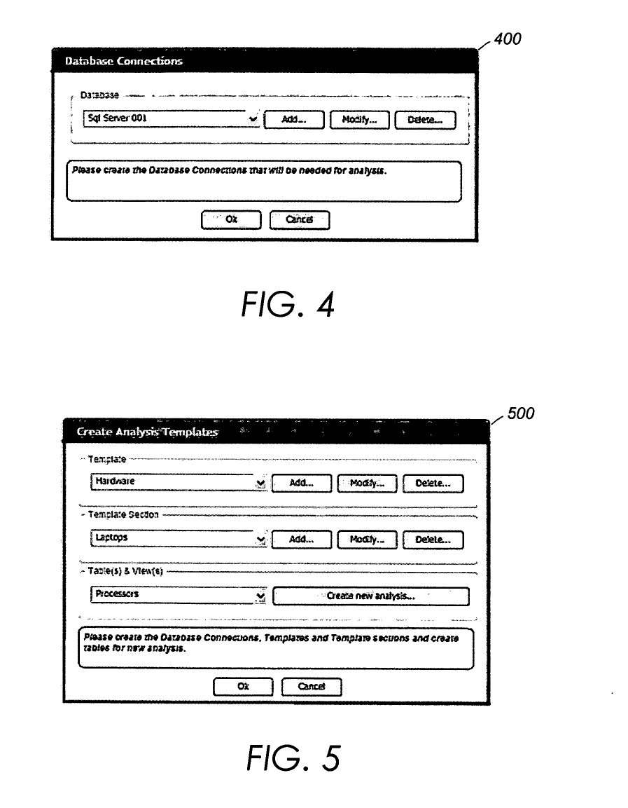

Referring to FIGS. 3 and 4, an embodiment of a form 400 generated by get database connection function 302 is shown that allows the user to add, modify, or delete the name of the database connection to indicate the database to be used for the analysis. Other embodiments can be configured to allow a user name and password and data source name or other that may be required to access the database 126 (FIG. 1). This information can be stored in template 120 and used by host application 104 or compare component 106 (FIG. 1) to establish a connection to the desired database 126. Note that form 400 can be configured to accept one or more database names, data sources, and/or username/passwords. The selections for the database connections can be presented and selected in a pull-down menu, from a list, or other suitable display technique, with the current selection(s) indicated and optionally highlighted.

Referring to FIGS. 3 and 5, FIG. 5 shows an embodiment of a form 500 generated by open/create analysis template function 304 of user interface component 118. In the embodiment shown, form 500 includes data entry sections for a template name, a template section, and database tables to be analyzed. A field entitled “Table & View” indicates the name of a database table or view. A view includes a SQL statement that describes a data selection. Multiple selections/entries can be displayed via a pull-down menu, a list, or other display technique. The data entry sections can include add, modify, and/or delete options to allow the user to customize the data to be analyzed, as specified by the template 120. Additionally, multiple template sections may be included in a template 120 and multiple tables may be included in a template section to allow various combinations of different tables to be analyzed. Once the data entry sections are completed, the user can select an option to create a new analysis template 120. Once all the desired analysis templates 120 have been created/modified/deleted, the user can select an option to proceed to the next user interface form. Alternatively, the user may select an option to cancel and exit the current user interface session.

When a template 120 is created, a set of set-up tables are generated and initialized for the template. The set-up tables identify the template and store information regarding the analysis to be performed. Parameters in the analysis set-up tables can be set to default values and added/modified/deleted by the user via user interface component 118. In some embodiments, the following analysis set-up tables can be generated:
AnalysisSet
   AnalysisSet_id
   AnalysisSetGUID—(globally unique identifier)
   AnalysisSetName
   AnalysisSource_id
AnalysisSetMembers
   AnalysisSet_id
   Analysis_id
Analysis
   Analysis_id
   AnalysisType_id
   AnalysisGUID
   Name
   Template
   TemplateSection
   Table
AnalysisStates
   AnalysisSet_id
   State_id

Reviewing the analysis tables above, an AnalysisSet can be associated with one or more AnalysisSetMembers and Analysis States. AnalysisSetMembers can be associated with one or more Analysis, wherein the Analysis corresponds to a particular template, template section, and table.

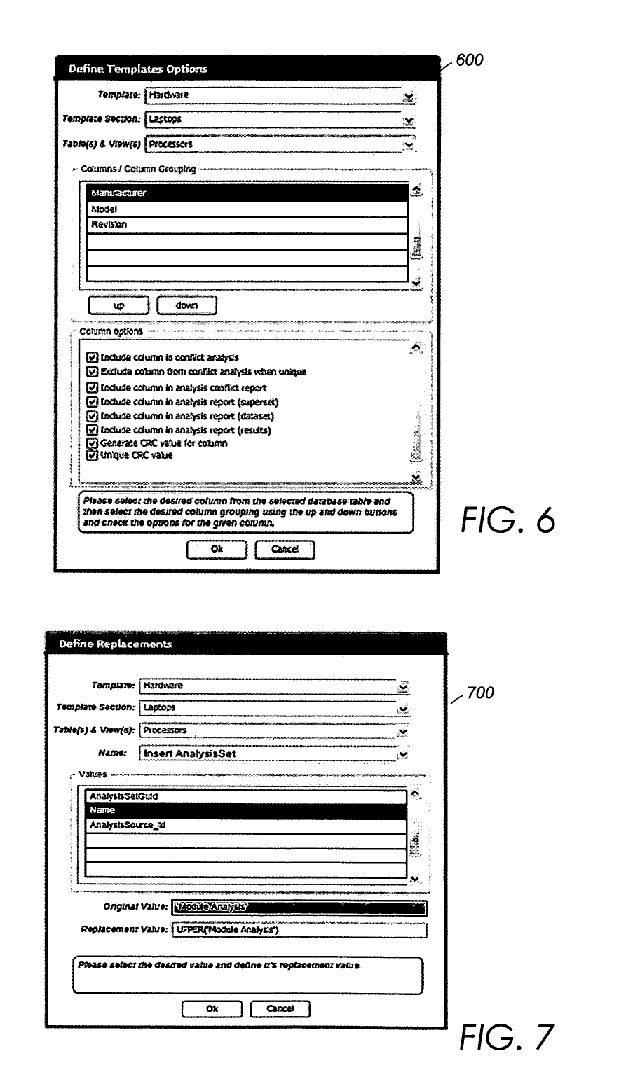

Referring to FIGS. 3 and 6, FIG. 6 shows an embodiment of a form 600 generated by define template options function 304 in user interface component 118. The template, template section, and table information can be populated based on the information entered in form 500. Additionally, a user can select from available templates, template sections, and tables via pull-down menus, lists, or other suitable technique. Once a template, template section, and table are selected in form 600, user interface 118 accesses database 126 to populate a list of the columns that are available in the selected table. The columns are typically presented in the order in which they are stored in the database 126, additionally, the user may change the order by moving selected column(s) up or down in the list to define an option that specifies a column grouping order to be used in group by and order by SQL statements generated by the analysis process. Additionally new column options may be added and stored in an analysis template to define selections that can be used to control the analysis SQL generation.

A user may also select various analysis and display/formatting options for the selected Analysis via form 600. In the embodiment shown, for example, the user may choose one or more of the following options:
include column in conflict analysis;
exclude column from analysis when column is unique;
include column in analysis report;
include column in superset analysis report;
include column in dataset analysis report;
include column in results analysis report;
generate cyclic redundancy check (CRC) value for column; and
unique CRC value.
   With respect to the options listed above, superset data is distinct data that is used to identify analysis results for a particular template, template section, and table, whereas dataset data includes the results of the analysis. A cyclic redundancy check (CRC) is a type of hash function used to produce a checksum against a block of data, such as a packet of network traffic or a block of a computer file. The checksum is used to detect errors after transmission or storage. A CRC is computed and appended before transmission or storage, and verified afterwards by recipient to confirm that no changes occurred on transit.

Once the desired column options have been selected, the user can select an option to proceed to the next user interface form. Alternatively, the user may select an option to cancel and exit the current user interface session or return to a previous form.

Referring to FIGS. 3 and 7, FIG. 7 shows an embodiment of a form 700 generated by user interface component 118 to enter replacement values and/or formats for parameters that are used in dynamic SQL statements to perform an analysis. In the embodiment shown, the template, template section, and tables information can be populated based on the information used in form 600. Alternatively, a user can select from available templates, template sections, and tables via pull-down menus, lists, or other suitable technique. Once a template, template section, and table are selected in form 700, the user can select for example the AnalysisSet or Analysis set-up tables to view and replace the values for the parameters in the set-up tables, if desired. For example, the AnalysisSet data table is selected and the values of the AnalysisSetGUID, Name, and AnalysisSource_id parameters are shown. A user can select one of the parameters to view the parameter's value and enter a replacement value for the original value, if desired. The replacement value can include formatting statements as well as different values for the parameters. The capability to replace parameters in the analysis set-up tables allows users to customize a template for different types of analysis. Once the desired replacement values have been entered, the user can select an option to proceed to the next user interface form. Alternatively, the user may select an option to cancel and exit the current user interface session or return to a previous form.

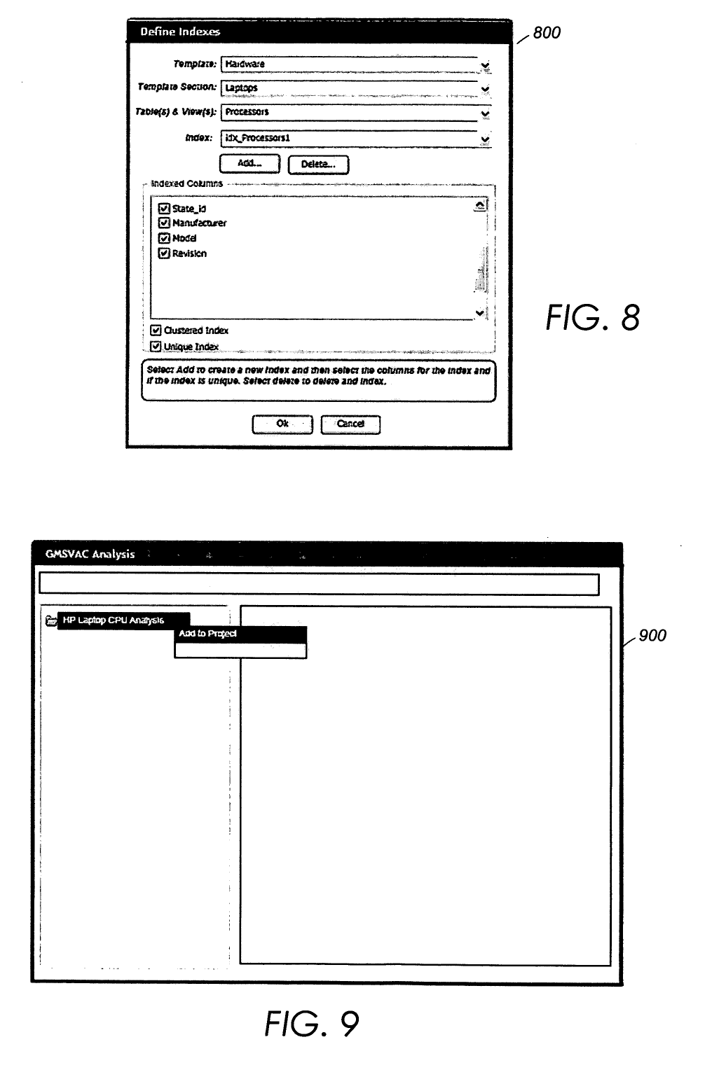

Referring to FIGS. 3 and 8, FIG. 8 shows an embodiment of a form 800 generated by user interface component 118 to define database table indexes for an analysis template. In the embodiment shown, the template, template section, and table or view information can be populated based on the stored templates and related database tables or views. Alternatively, a user can select from available templates, template sections, and tables via pull-down menus, lists, or other suitable technique. Once a template, template section, and table or view are selected in form 800, the user can enter a new table index name, or select a previously-entered table index name from a pull-down menu, and then select an “Add” or “Delete” option, depending on whether the user wants to add or delete the table index. Once the index is entered, a list of columns indexes is presented in form 800. The column indexes are pulled from the analysis template. Options can be further provided on form 800 to allow the user to indicate whether the index is a clustered index or a unique index to allow for indexing the source analysis data present on the database server. Once the desired indexes have been defined, the user can select an option to proceed to the next user interface form. Alternatively, the user may select an option to cancel and exit the current user interface session or return to a previous form.

Referring to FIGS. 3 and 9, FIG. 9 shows an embodiment of a form 900 generated by user interface component 118 to add a template to a project in a workspace. When user interface component 118 initializes, a workspace can be selected or added, and a number of projects can be added to the workspace. For example, in FIG. 9, the project is shown as “HP Laptop CPU Analysis”. States to be analyzed can then be added to the project. As used herein, a state is a database entity that includes references to criteria, rules, rulesets or rulesetgroups that describe the source data for an analysis in terms of an SQL statement.

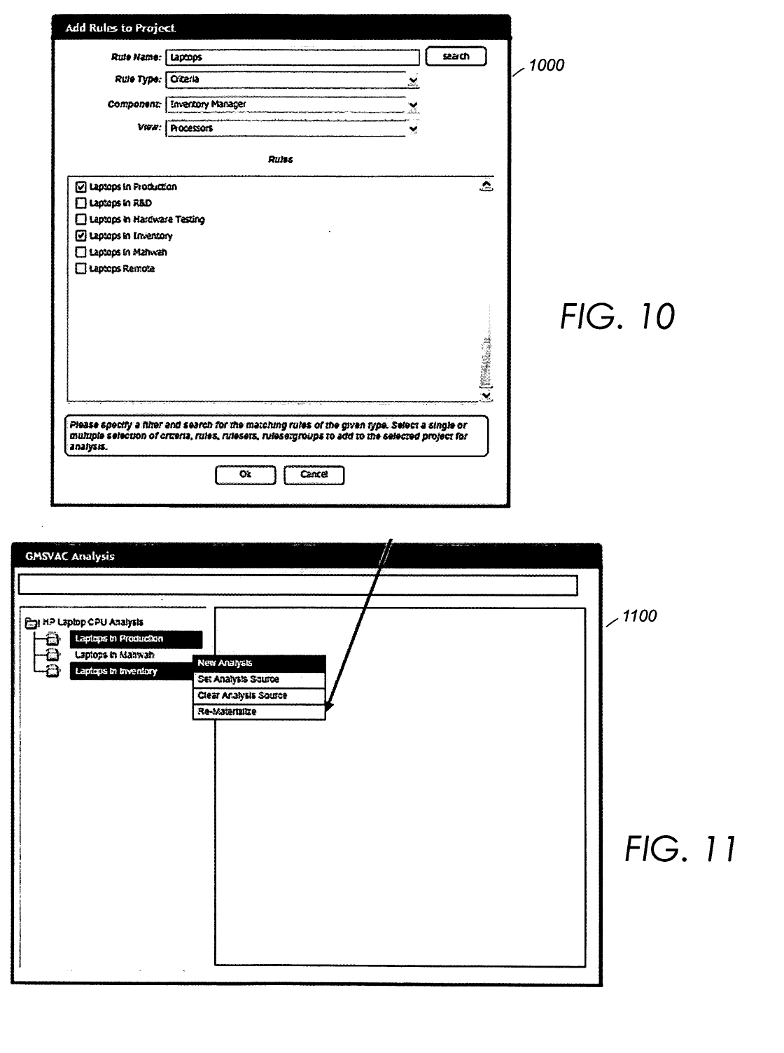

If the user selects the option “Add to Project”, then the user proceeds to form 1000 (FIG. 10) to add state entities containing references to criteria, rules, rulesets or rulesetgroups that define the source data for an analysis to the selected project.

Referring to FIGS. 3 and 10, FIG. 10 shows an embodiment of a form 1000 generated by user interface component 118 to add rules to the project selected in form 900. To determine whether any rules are currently available or to create new rules, the user can enter a keyword, a rule type (e.g., criteria, rules, rule sets, or rule set groups), a management component (e.g., usage manager, inventory manager, or patch manager), and a view to be queried. A search option can then be selected. The rules found during the search are displayed in form 1000 along with an option to include the rule in the selected project analysis. In the example of form 1000 shown, the keyword searched is “Laptop”, the rule type is “Criteria”, the Component is “Inventory Manager” and the view is “Processors”. The available rules for the example are:
Laptops in Production
Laptops in R&D
Laptops in Hardware Testing
Laptops in Inventory
Laptops in Mahwah
Laptops in Remote
   The user can select any one or more of the available rules for the analysis. Note the rules “Laptops in Production” and “Laptops in Inventory” are selected in the example shown in form 1000. Once the desired rules have been selected, the user can select an option to proceed to the next user interface form. Alternatively, the user may select an option to cancel and exit the current user interface session or return to a previous form.

Referring to FIGS. 3 and 11, FIG. 11 shows an embodiment of a form 1100 generated by user interface component 118 to invoke compare component 106 to perform the database analysis. A user can select one or more of the rules shown for the project. If more than one rule is selected, the data associated with each rule is compared against the data that is considered the “source” data. Options to perform a New Analysis, Set Analysis Source, Clear Analysis Source, and Re-Materialize (refresh) an analysis can be selected next to a rule. A state table can also be associated with each rule in a project. In one embodiment, the following information can be included in a state table, as shown for example as follows:

| Parameter | Description |
|---|---|
| State_id | State identifier (also used in analysis set-up tables |
| | above) |
| SearchType | An idenifier of a type of database view |
| Product_id | Key into table of product information types |
| View_id | Identifier of index into a table that includes names of |
| | database views |
| Criteria_id | Identifier of criteria that describes a SQL statement |
| | in a group of tables, as entered in Form 1000 |
| Rule_id | Identifier of a group of criteria, as entered in Form |
| | 1000 |
| RuleSet_id | Identifier of a group of rules, as entered in Form |
| | 1000 |
| RuleSetGroup_id | Identifier of a group of rule sets, as entered in Form |
| | 1000 |
| Materialized | Flag indicating whether source data has been rendered |
| | on the database server |

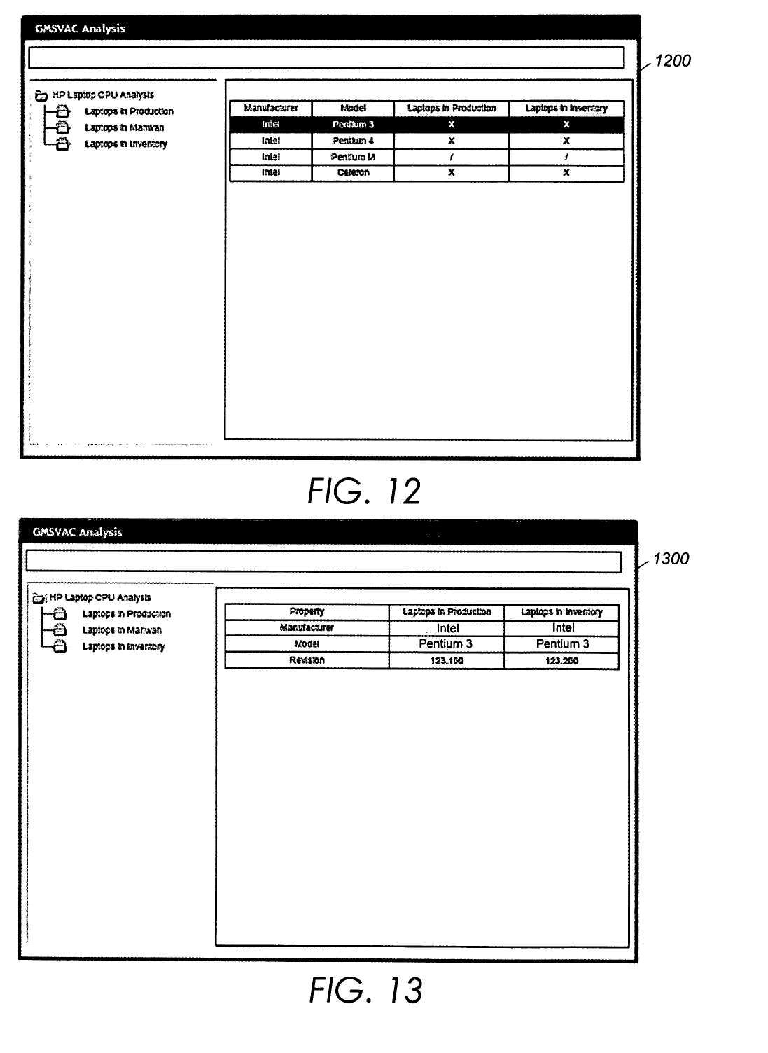

Referring to FIGS. 3 and 12, FIG. 12 shows an embodiment of a form 1200 generated by user interface component 118 to display results of the analysis. The results of the analysis can be stored in tables, such as shown in the examples of analysis tables below:

Source Analysis Data Table

```
src_TableView
  State_id
  Column1
  ....
  ColumnN
  CRC
```

SuperSet Analysis Data Table

```
ss_TableView
  Analysis_id
  CRC
  Column1
  ....
  ColumnN
  Filter
  Conflict
  ComparisonSource
```

DataSet Analysis Data Table

```
ds_TableView
  Analysis_id
  State_id
  CRC
  DataElement
```

The user can control the information associated with the analysis that is displayed. For example, in form 600 (FIG. 6), the user can select column options to modify the behavior of the anaysis. Options can be specified to include or exclude columns from an analysis, analysis report or from the analysis processing provided by generated SQL statements. The analysis tables are generated and maintained by the analysis component 112 (FIG. 1) for each state entity reference in an analysis project. The embodiment of form 1200 shown includes the project and the available rules along with a table that includes superset data (e.g., Manufacturer and Model), and dataset data (e.g., “Laptops in Production” and “Laptops in Inventory”).

In the example analysis tables shown above, the Source Analysis Data Table includes information regarding the baseline source table that is used for the analysis. All other tables are compared to the baseline source. Note that the analysis can include a comparison with one or more other tables.

The example of the Superset analysis data table shown above includes the columns of data analyzed, the columns included in the analysis, a filter flag that indicates the desired analysis filtering, a conflict flag that indicates whether conflicts between the source and comparison exist for possible display (from form 600), and the comparison source that is analyzed against the baseline source.

The example of the Dataset analysis data table shown above includes the Analysis_id, State_id, CRC flag, and DataElement. The DataElement includes data from the analysis, such as a value indicating whether a conflict was found between the source and the comparison data.

Referring to FIGS. 3 and 13, FIG. 13 shows an embodiment of a form 1300 generated by user interface component 118 to display further detail of the results of the analysis. A user can select a particular row in form 1200 to request further detail. Form 1300 shows that the conflict between the source and comparison data is the Revision level of the Intel Pentium 3 processor. A user can then make the required upgrades to the laptops in production so that all laptops are at the same revision level, if desired.

FIG. 14 shows components included in an embodiment of the compare component 106 of FIG. 1, in particular, add to/remove from comparison function 1402, sort columns function 1404, invoke analyzer function 1406, get result set function 1408, add state function 1410, and create file name function 1414.

Add to/remove from comparison function 1402 uses information from forms 500 and 600 to organize the data to be analyzed.

Sort columns function 1404 uses information from form 600 to organize the columns of data to be analyzed in the order specified by the user.

Invoke analyzer function 1406 invokes analyzer component 108 (FIG. 1). Analyzer component 108 determines whether one or more than one table is to be compared to the baseline source data, and then compares the data in the specified tables according the rules selected by the user via form 1000 (FIG. 10). Analyzer function 108 can invoke analyzers function 110 when multiple tables are being compared/analyzed.

Get result set function 1408 can be executed to gather the results of the analysis of one of the comparison tables against the source table.

Add state function 1410 can be executed to include data specified by one or more of the state entity references in form 1000 (FIG. 10).

Invoke analysis component function 1414 is executed after an analysis is complete to invoke the analysis component 112 (FIG. 1) to create/maintain the analysis data tables shown hereinabove. Note that the results from an analysis can be saved, loaded, or deleted via the analysis component 112.

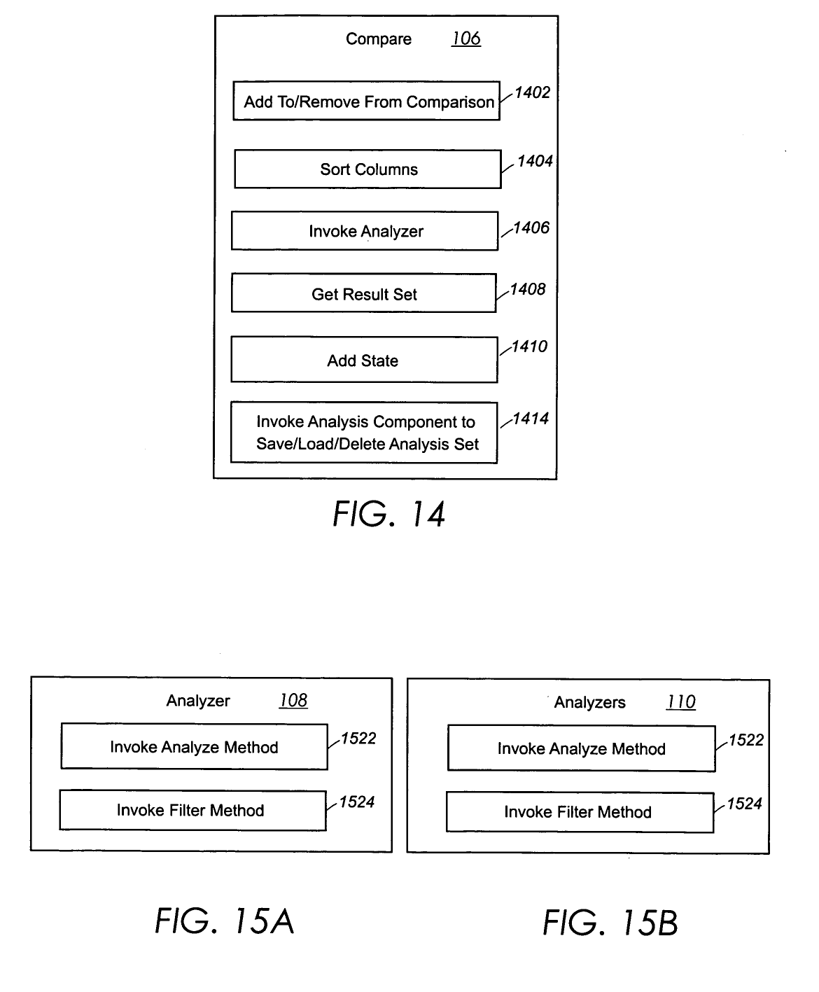

FIGS. 15A and 15B show components included in embodiments of the analyzer component 108 and analyzers component 110 of FIG.1. In the embodiment shown, both of the components 108, 110 invoke an analyze method 1522 and a filter method 1524. The difference is that analyzer component 108 invokes the analyze method 1522 and a filter method 1524 for one table, whereas analyzers component 110 is used to analyze multiple tables.

Analyze method 1522 generates dynamic SQL statements to perform the analysis based on the template 120 and creates/updates the state and analysis set-up tables further described herein.

Filter method 1524 filters results of the data table(s) analysis. For example, options or properties can be set to filter the results according to shared data, non-shared data, data that conflicts between the source and the comparison data tables, and/or data without conflicts between the source and the comparison data tables. The filter options can be set via application 104, user interface 118, or other suitable method. For example, the options can be entered via template 120, a file that is read by host application 104, and/or via display options as the analysis results are displayed via user interface 118.

The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components are disclosed herein as separate and discrete components. These components may, however, be combined to form larger or different software modules, logic modules, integrated circuits, or electrical assemblies, if desired.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

What is claimed:

1. A computer product comprising:
computer readable media including logic instructions operable to:
allow a user to create a template for analyzing data in a database, wherein the template specifies at least one table, columns from the at least one table to be included in the analysis, and analysis options for the columns, wherein the options for one of the columns are independent from the options for other of the columns.

2. The computer product of claim 1, wherein the options for the columns allow the user to specify whether to:
include the one of the columns in the analysis with data from the other of the columns; and
exclude the one of the columns from the analysis when the one of the columns is unique.

3. The computer product of claim 1, wherein the options for the columns allow the user to specify whether to include the one of the columns in an analysis conflict report.

4. The computer product of claim 1, wherein the options for the columns allow the user to specify whether to include superset information for the one of the columns in an analysis report, wherein the superset information includes an analysis identifier, columns analyzed, and at least one of the group consisting of: a filter flag, a conflict flag, and a comparison source identifier.

5. The computer product of claim 1, wherein the options for the columns allow the user to specify whether to include dataset information for the one of the columns in an analysis report, wherein the dataset information includes an analysis identifier, a state identifier, and a data element.

6. The computer product of claim 1, wherein the options for the columns allow the user to specify whether to include results of the analysis in a report.

7. The computer product of claim 1, wherein the options for the columns allow the user to specify whether to generate a cyclic redundancy check (CRC) value for the one of the columns.

8. The computer product of claim 1, wherein the options for the columns allow the user to specify whether a cyclic redundancy check (CRC) value for the one of the columns is unique.

9. The computer product of claim 1, wherein the options for the columns allow the user to specify a desired grouping for the columns.

10. The computer product of claim 1, wherein the logic instructions are further operable to allow the user to specify a template section when multiple template sections are included in the template.

11. The computer product of claim 1, wherein the computer readable media further includes logic instructions operable to:
allow the user to specify rules for a project, wherein a rule specifies a state of the data to be analyzed.

12. The computer product of claim 11, wherein the computer readable media further includes logic instructions operable to:
allow the user to group the rules in a project and to specify whether the data associated with the rule is to be used as source data for the analysis.

13. The computer product of claim 1, wherein the computer readable media further includes logic instructions operable to:
allow the user to select an option to refresh the analysis.

14. The computer product of claim 1, further comprising a computer processor configured to execute the logic instructions.

15. A computer system comprising:
a user interface component operable to:
allow a user to create a template for analyzing groups of data in a database, wherein the template specifies the groups of data to be included in the analysis and options for analyzing the groups of data; and
allow a user to specify a project and rules for the project, wherein the rules pertain to states in the groups of data and the project indicates which of the groups of data is baseline source data and which of the groups of data is comparison data;
a compare component operable to:
access the template, the project, and the groups of data; and
invoke an analyzer function to compare the source data to the comparison data.

16. The computer system of claim 15, wherein the compare component is further operable to sort the groups of data according to the options in the template.

17. The computer system of claim 15, wherein the analyzer function is
operable to access the options in the template to determine whether to:
include a column in a group of the data in the analysis; and
exclude the column from the analysis when the column is unique.

18. The computer system of claim 17, further comprising an analysis component operable to access the options to determine whether to include the column in an analysis conflict report.

19. The computer system of claim 15, wherein the options allow the user to specify whether to include superset information in an analysis report, wherein the superset information includes at least one of the group consisting of: an analysis identifier, columns analyzed, a filter flag, a conflict flag, and a comparison source identifier.

20. The computer system of claim 15, wherein the options allow the user to specify whether to include dataset information in an analysis report, wherein the dataset information includes at least one of the group consisting of: an analysis identifier, a state identifier, and a data element.

21. The computer system of claim 15, wherein the options allow the user to specify whether to include results of the analysis in a report.

22. The computer system of claim 15, wherein the options allow the user to specify whether to generate a cyclic redundancy check (CRC) value.

23. The computer system of claim 15, wherein the options allow the user to specify a desired order for the groups of data.

24. The computer system of claim 15, wherein the template includes multiple template sections.

25. A method for analyzing data in a database, comprising:
creating an analysis template, wherein the template specifies at least one of the group consisting of: columns of data in the database, options for analyzing the columns of data, and options for generating a report of the analysis;
adding a project,
adding rules to the project, wherein the rules correspond to states of the data, and one of the columns of the data is designated as source data and other of the columns is designated as comparison data to which the source data is compared; and
comparing the source data to the comparison data based on the template and the rules in the project.

26. The method of claim 25, further comprising generating a report of the analysis based on the options in the template.

27. The method of claim 25, further comprising generating a set of analysis tables for the rules, wherein the analysis tables include:
an AnalysisSet table that specifies an AnalysisSet identifier and an AnalysisSource identifier;
an AnalysisSetMembers table that specifies the AnalysisSet identifier and an Analysis identifier;
an Analysis table that specifies the Analysis identifier, and AnalysisType identifier, a Template, and a Table; and
an AnalysisStates table that specifies the AnalysisSet identifier and a State identifier.

28. The method of claim 25, further comprising generating a set of analysis tables, wherein the analysis tables include:
a superset data table including an Analysis identifier, at least one of the rules, a filter flag, a conflict flag, and a comparison source flag.

29. The method of claim 25, further comprising generating a set of analysis tables, wherein the analysis tables include:
a dataset data table including an Analysis_id, a State_id, a CRC flag, and a DataElement.

30. The method of claim 27, further comprising defining replacement values for one or more parameters in the analysis tables.
